(19) United States
(12) Patent Application Publication
(10) Pub. No.: US 2023/0373856 A1
(43) Pub. Date: Nov. 23, 2023

(54) DOUBLE ENCAPSULATED STYRO-AIRCRETE BUILDING PANELS

(71) Applicant: Philip Bradley, Oakville (CA)

(72) Inventor: Philip Bradley, Oakville (CA)

(21) Appl. No.: 17/751,468

(22) Filed: May 23, 2022

(51) Int. Cl. C04B 16/08; E04C 2/28; E04B 2/00; E04C 3/29; C04B 24/26

(52) U.S. Cl. CPC C04B 16/087; E04C 2/28; E04C 2/46; E04C 3/29; C04B 24/2623; C04B 2103/42

(57) ABSTRACT

The present disclosure provides designs and methods for manufacturing precast fully-encapsulated bilayered fiberglass Styro-aircrete building blocks. The disclosure comprises forming a super-light air-entrained Styro-aircrete building panel for a wall, roof, or beam. The Styro-aircrete is made with a novel composition/formula using shredded Styrofoam and other traditional Styro-aircrete ingredients that are mixed. Wire meshes and fiberglass fibers are pre-embedded in the panel frame to keep the structure in place. The Styro-aircrete is poured into a fiberglass panel frame from an opening, set aside to dry for a few days, and then sealed with a fiberglass cover. This frame and cover are double-layered fiberglass and form an all six-side enclosed casing. The method and designs improve a Styro-aircrete building block with the following: (1) much lighter weight; (2) longed durability; (3) increased compressive strength for load-bearing support; (4) reduced cost and installation time.

### FIELD

The present disclosure is in the field of architecture, civil engineering, construction, building, precast construction panels, fiberglass, Styrofoam encased air-entrained concrete, and especially, a type of double-layer-fiberglass encapsulated air-concrete building blocks, like panels or beams.

### BACKGROUND

Precast concrete is a construction product generated by casting concrete into a moldable form. It is first made off-site using cement mixed with aggregates like sand, gravel, stone, or fill. The concrete is set aside to cure and transported to a construction site for use. Hereinafter, the term ‘cure’ may be interchangeably referred to as ‘dry’ or ‘harden’ when referring to the solidification of concrete. Most commonly, precast concrete is formed into precast blocks like panels widely used in construction projects, specifically the construction of buildings. Precast panels are one type of precast block used for building construction, i.e., a building block or building panel. Each panel can be arranged in a group to form a part of a building function, such as an interior or exterior wall, ceiling, roof, floor slab, beam, etc. Precast panels are often rectangular but can be curved or round. More specific functions for precast panels include insulation, soundproofing, aesthetics, etc. Precast concrete has provided a low-maintenance, durable, and long-life solution for building construction for many decades.

Besides all the above good aspects, however, traditional precast concrete panels face many challenges. They are still relatively expensive. They are heavy, making them hard to transport and handle. Specialized equipment (e.g., large trucks, cranes, etc.) is often needed to transport, carry, and handle these precast elements; handling such equipment takes considerable skill and training; otherwise, it may result in damage or injury. Another problem is that precast panels may not be easily readjusted once put into place. The third problem is the insulation of the building panels may be required to be even better in many cases. Overall, if possible, a better precast material and building block or panel are needed.

One existing solution to the problems is the use of so-called light-weighted concrete. One primary example of such a product is foamed concrete, also known as ‘air concrete’, ‘Styro-aircrete’, ‘aircrete’, ‘foam aircrete’, ‘EPS aircrete’, or ‘air-entrained concrete’. Hereinafter, the aforementioned terms may be used interchangeably. Styro-aircrete concrete uses a cement and water slurry with a foaming agent and foam pieces added into the mixture. The ingredients are mixed, causing a chemical reaction within the mixture that creates gas bubbles within the Styro-aircrete. As a result, the finished product is much lighter and has a high degree of insulation.

Furthermore, Styro-aircrete can be made cheaply and quickly compared to traditional concrete. However, when high densities of foam are included, Styro-aircrete can become brittle, leaving it prone to damage from chipping or cracking. Although Styro-aircrete has fairly good compressive strength, it is limited compared to traditional concrete. As a result, Styro-aircrete is not ideal as a load-bearing material, limiting its use as a building element. Furthermore, Styro-aircrete panels can still be heavy and face the same problems as traditional concrete panels. Therefore, an even lighter Styro-aircrete panel is needed.

Some Styro-aircrete panels have a fiberglass layer added to the panel's outer surface. The fiberglass layer helps add some protection to the Styro-aircrete panel. Assuming most of the panels are rectangular prisms, they can be of other shapes like a triangular pyramid or prisms whose bases have four or more sides. However, fiberglass layering is only added to one or two bases or sides of the panel, typically at the larger sides called bases. The other four or more ‘side’ faces or sides are called lateral faces or sides. For an existing building panel block with fiberglass on its two bases, the lateral sides are all exposed (not covered by fiberglass). This results in the following issues: (1) the panel has less strength against external forces like compression and tension. Because the fiberglass layers are typically applied to the bases (i.e., larger panel sides/faces) of the panel, and the four lateral sides (i.e., smaller panel sides) are left open. The inner Styro-aircrete of a traditional precast Styro-aircrete panel will act as a form of load-bearing support along. (2) the whole panel is prone to cracking and structural compromise. A cracking can still appear on the exposed lateral sides of a building panel. Once the cracking becomes large enough, the cracked Styro-aircrete particles may shift and move, and the whole building panel may eventually collapse and fail. (3) when a panel is cracking, other adjacent panels may also crack through the connected opening lateral sides due to spread damage leading to a chain reaction of damaged building panels. (4) because the lateral panel sides are open, the moist, moss, bugs, plant seeds, and other objects may enter easily and damage the panel's inner structure over time or due to temperature differences. Overall, a better enclosed Styro-aircrete panel may achieve better properties and durability.

The fiberglass layer on the bases of all existing products is only a single layer, which may wear down soon over time. Once that fiberglass layer breaks, the whole panel may get more exposed, lose compression support, and become entirely compromised. Such failure would affect the core structure of a Styro-aircrete panel, potentially leading to a collapse later on.

The present disclosure provides a novel method and design for precast bilayered fiberglass encapsulated Styro-aircrete construction block that can be used as at least wall panels, support beams, roof panels, etc. The method and designs improve at least the following aspects: (1) improved durability; (2) 65 much lighter weight; (3) increased compressive strength for load-bearing support; (4) reduced cost and installation time.

### SUMMARY

The present disclosure provides a method and a new set of designs for precast fully-encapsulated with bilayered fiberglass Styro-aircrete building blocks like panels and support beams with a plurality of improvements over the traditional counterparts. The purposes of the present disclosure are to increase their durability, compressional strength, and resistance against weather and significantly reduce their weight and cost. The method comprises the formation of fully encapsulated super-light air-entrained concrete in the shape of one of the standard building blocks like panels. The design comprises the Styro-aircrete building panel with embedded wire meshes and fiberglass fibers; each panel is double encapsulated within a six-sided bilayered fiberglass framing case. The building panel blocks generally have a rectangular prism structure in one of the preferred embodiments of the present disclosure. The new set of designs allows the panel to be used as a wall panel, roof panel, support beam, or other functions. The present disclosure provides at least the following aspects of this invention: (1) a fiberglass frame or case encapsulating all six sides of the panel; (2) said fiberglass frame being made bilayered (with two layers) for added strength and durability; (3) a novel composition and process to make Styro-aircrete; (4) embedded wire meshes and fiberglass fibers structured in various enforcement arrangements.

The first aspect of the present disclosure involves a fiberglass frame or case that encloses an entire building block. The fiberglass frame covers and protects all six sides of a standard building panel/block, leaving no sides exposed. At the start of the panel's manufacturing process, the fiberglass case starts as a panel frame with one side open for access (e.g., the top side of the panel). Wire meshes and fiberglass fibers are then arranged and put inside from the frame's opening space, and the Styro-aircrete mixture is poured into the frame shortly after. Once the mixture dries inside, the opening side of the frame is sealed with a fiberglass cover, then the entire frame (all six sides) is closed. The all-sealed fiberglass casing provides improved durability and strength to the panel from damage coming from the environmental, external elements, pressure, and forces. Compared to other casing structures that leave one or more lateral sides open, a six-sided full enclosure dramatically increases the panels' supporting strength. The material used for the frame itself also helps to make the panel lighter.

The second aspect is the fiberglass frame or casing being made bilayered. The term bilayered refers to a structure of two layers of material layered immediately to each other. The fiberglass casing contains two layers of fiberglass, with one layer immediately on top of the other. Specifically, one can consider that an inner fiberglass layer protects the Styro-aircrete and an outer fiberglass layer protects the whole panel. This is why the structure sometimes is also called double encapsulation. The bilayered fiberglass casing provides greatly improved compressive strength as a load-bearing structure that supports heavier weights or loads. The bilayered fiberglass casing also increases the panel's durability. This is because once there is a cracking happening in one of the fiberglass layers, unless another same shaped and sized cracking occurs at the exact location of the second layer of the fiberglass, the whole bilayered panel frame can still stand and support. While the change to have both fiberglass layers having cracked at the exact location with the same size and shape is almost impossible. Therefore, the bilayer design can significantly improve the panel's durability.

The third aspect involves a novel super-light Styro-aircrete composition and a process and formula to create it. The novel Styro-aircrete is air-entrained, making the panel light yet solid and durable. The novel Styro-aircrete formula entails a bag of 94 pounds of Portland cement, 0.5 liter PVA glue, 27.25 liters (6 gallons) of water, 94 liters of high-density pre-formed foam (surfactant), and 204 liters of shredded Styrofoam. The high-density foam weight should be between 90-100 grams or approximately 3 ounces per quart. If the foam is heavier, it should increase the air pressure, or if the foam is lighter, it should decrease air pressure. When the cement and water slurry are combined with the foam, this distributes many discrete air cells uniformly throughout the mixture. Glycerin and foaming agent, another part of the formula, is added to the water before mixing everything to ensure the bubbles stay inflated during the Styro-aircrete formation. This mixture is then poured into a fiberglass frame described previously and set aside. As the concrete hardens, the bubbles disintegrate, leaving air voids of similar sizes to create lightweight concrete. Once it dries after a few days, a bilayered fiberglass cover is added to seal the last opening side of the whole frame. Thus, the fiberglass frame now fully encloses the entire Styro-aircrete panel. This novel super-light Styro-aircrete composition/formula with an additional said amount of shredded Styrofoam makes the Styro-aircrete even lighter in weight (up to ten times lighter) than existing Styro-aircrete compositions. The Styro-aircrete formula may allow each component amount to vary by ±20%. The new composition saves time since it can be made more quickly than traditional methods. This is because the Styrofoam aggregation assists with water being wicked away faster from the drain concrete. Furthermore, it does not need specialized training or equipment, which also reduces costs.

The fourth aspect of the present disclosure involves one or more structured embedded wire meshes and fiberglass fibers for binding the Styro-aircrete and preventing it from cracking and shifting. Simple wire gauge meshes can be used. The wire can be iron, steel, copper, or hard plastic. The mesh can be other non-wired sheets too, such as linen sheets, tarp, gunny cloth, etc. The meshes are inserted into the fiberglass frame before pouring the Styro-aircrete mixture. The fiberglass fibers are added to the concrete mix. The embedded wire meshes and fiberglass fibers are structured in various arrangements or shapes to enforce the structural integrity of the building panel in a better way; the arrangements are dependent on what type of building panel is used. The mesh shapes and arrangements extend a significant part of the fiberglass frame. The mesh layer arrangement helps prevent internal Styro-aircrete cracked pieces from shifting within the Styro-aircrete panel, which maintains structural integrity. In a sense, both the durability and strength of the panel can be improved.

By using the technologies above, the overall installation and use of building panels for construction are improved by achieving the following: (1) enhanced durability thanks to the bilayered fiberglass casing on all six sides of the panel frame and the embedded wire meshes and fiberglass fibers; (2) much lighter weight (approximately ten times less) than existing concrete compositions primarily thanks to the novel Styro-aircrete manufactural formula and process; (3) increased strength for supporting heavier loads thanks to the bilayered fiberglass casing and the embedded wire meshes and fiberglass fibers; (4) reduced costs and installation time thanks to the novel Styro-aircrete composition/formula drying more quickly than traditional concrete, much lighter than existing building blocks, and requiring less equipment and training during installation.

### BRIEF DESCRIPTION OF THE DRAWINGS

The accompanying drawings, which are included to provide a further understanding of the invention and are incorporated in and constitute a part of this application, illustrate embodiment(s) of the present disclosure and, together with the description, serve to explain the principle of the invention. For simplicity and clarity, the figures of the present disclosure illustrate a general manner of construction of various embodiments. Descriptions and details of well-known features and techniques may be omitted to avoid unnecessarily obscuring the discussion of the present disclosure's described embodiments. It should be understood that the elements of the figures are not necessarily drawn to scale. Some elements' dimensions may be exaggerated relative to other elements to enhance the understanding of described embodiments. In the drawings:

FIG. 1 illustrates perspective and top views of two wall panels in one embodiment of the present disclosure.

FIG. 2 illustrates perspective, cross-section, and top views of a roof panel in one embodiment of the present disclosure.

FIG. 3 illustrates perspective and cross-section views of a beam in one embodiment of the present disclosure.

FIG. 4 illustrates the use of a fiberglass binding layer on two wall panels and two roof panels.

FIG. 5 illustrates side cross-section views of a wall panel attaching to a floor slab and roof panel.

FIG. 6 illustrates a flowchart of a preferred embodiment of the super-light Styro-aircrete manufacturing details of the present disclosure.

FIG. 7 illustrates top cross-section and exploded perspective views of the super-light Styro-aircrete of the present disclosure.

### DETAILED DESCRIPTION

The present disclosure provides a method and new designs for precast fully-encapsulated bilayered fiberglass Styro-aircrete building blocks like panels and beams with a plurality of improvements over the traditional precast Styro-aircrete and aircrete building panels. Various examples of the present invention are shown in the figures. However, the present invention is not limited to the illustrated embodiments. In the following description, specific details are mentioned to understand the present disclosure better. However, it may likely be evident to a person of ordinary skill in the art; hence, the present disclosure may be applied without mentioning these specific details. The present disclosure is represented as a few embodiments; however, the disclosure is not necessarily limited to the particular embodiments illustrated by the figures or description below.

The language employed herein only describes particular embodiments; however, it is not limited to the disclosure's specific embodiments. The terms “they”, “he/she”, or “he or she” are used interchangeably because “they”, “them”, or “their” are considered singular gender-neutral pronouns. The terms “comprise” and “comprising” in this specification are intended to specify the presence of stated features, steps, operations, elements, and components; however, they do not exclude the presence or addition of other features, steps, operations, elements, components, or groups.

Unless otherwise defined, all terminology used herein, including technical and scientific terms, have the exact definition as what is commonly understood by a person of ordinary skill in the art, typically to whom this disclosure belongs. It will be further understood that terms, such as those defined in commonly used dictionaries, should be interpreted as having the same meaning as defined in the context of the relevant art and the present disclosure. Unless explicitly described herein, such terms should not be construed in an overly strict sense. It should be understood that multiple techniques and steps are disclosed in the description, each with its benefit. Each technique or step can also be utilized in conjunction with a single, multiple, or all of the other disclosed techniques or steps. For brevity, the description will avoid unnecessarily repeating each possible combination of the steps. Nonetheless, it should be understood that such combinations are within the scope of the disclosure. Reference will now be made in detail to some embodiments of the present invention, examples of which are illustrated in the accompanying figures.

The bilayer fiberglass encapsulated Styro-aircrete panel in the preferred embodiment is generally rectangular in one of the preferred embodiments of the present disclosure. The panel designs in the present disclosure can be used as a wall panel, roof panel, supporting beam, or any other suitable building element or block, depending on the embodiment. As a result, the panel's dimensions, namely the length, width, and height, may vary depending on the embodiment. Individual Styro-aircrete panels can be aligned together side-by-side or top-to-bottom, where they are bound with a separate fiberglass binding layer sheet. Specifically, Styro-aircrete panels used of the same building element/type (e.g., both are wall panels) or those used of different building elements/types (e.g., one is a wall panel, another is a roof panel) can both be bound with another sheet of fiberglass binding layer.

The fiberglass binding layer can bind one Styro-aircrete panel to another non-Styro-aircrete panel. For example, a Styro-aircrete wall panel can be bound to a non-Styro-aircrete floor slab. Although this binding layer is not a novelty aspect of the present disclosure, it is an integrated step in efficiently assembling multiple Styro-aircrete panels.

In the first aspect of the present disclosure, the Styro-aircrete panel is encased in a panel frame or casing that encapsulates all six sides of a rectangular prism building panel. The term ‘encapsulates’ is interchangeable with ‘encase’, ‘protect’, and ‘cover’ when referring to the panel casing. In one of the preferred embodiments, the panel casing is made of fiberglass; hereinafter, the term ‘panel frame/casing’ is interchangeable with ‘fiberglass frame/casing’. The fiberglass casing starts as a hollow rectangular prism panel frame that encapsulates all but one side, e.g., the top side. The top side is an opening where wire meshes and fiberglass fibers can be arranged and installed inside the panel frame before the Styro-aircrete mixture is poured. Once the Styro-aircrete mixture dries and hardens, the exposed side at the top of the frame is sealed with a fiberglass cover. The fiberglass casing provides improved durability for the panel and panel strength. Since no sides of the Styro-aircrete panel are exposed, it is effectively shielded from cracking or breaking apart, moss, animals, plant seeds, and other objects may enter the panel easily and damage the panel's inner structure over the time, and other environmental factors like temperature differences, moisture, etc. The fiberglass casing may crack and break down over time, but the fiberglass frame becomes much more robust with all four lateral sides fully enclosed and supported. It lasts longer than those panels, with one or more sides remaining open.

Additionally, the panel's fiberglass casing can protect against external weather conditions, such as wind, heat, or rain. For example, if rainwater seeps through the external cladding of a building, the fiberglass casing shields the Styro-aircrete panel from water. As the fiberglass material for the panel frame is both strong and lightweight, the fiberglass casing is a minor factor in the lighter weight of the panel, as the material itself does not significantly contribute to the panel's weight.

The second aspect of the present disclosure is related to the first aspect, which is the fiberglass panel casing that encases the panel that has double fiberglass layers. This structure is defined and called bilayer fiberglass in the present disclosure. It can be considered that an inner fiberglass layer encases all sides of the Styro-aircrete panel and an outer fiberglass layer encases all sides of the inner fiberglass layer and the Styro-aircrete within. Each fiberglass layer has the same thickness on all sides. The thickness of the first fiberglass layer may or may not be the same. All the descriptions from the above first aspect may all apply to the bilayer fiberglass panels. The presence of two fiberglass layers improves many things relating to building panels. The dual fiberglass layers add strength and durability to the Styro-aircrete panel with the best benefit-to-cost ratio. This can be manifested in two ways: (1) the panel's strength, specifically the compressional strength, has been improved. The panel can act as a stronger load-bearing element.

For example, a first-floor Styro-aircrete wall panel can now support many stories above it without risking damage (e.g., cracking) that could lead to a structural compromise. In other words, multiple Styro-aircrete panels can be piled up on top of one another due to the added strength of two fiberglass sheets. This, in turn, can save transportation costs, as they can be stacked on top of one another for transportation with fewer vehicles; (2) the durability of the panel is much improved. No matter which layer of the two layers breaks first, or there are cracks on both layers, such cracks and damages are unlikely of the similar size and shape, and also happening at the exact area location on both inner and outer fiberglass layers of the panel. As long as one of the above conditions (size, shape, location) does not meet, the panel may still survive without completely breaking down. In often cases, the outer fiberglass layer may crack and break first. However, the inner fiberglass layer can still protect the Styro-aircrete, provided that no cracking or breaking of the inner fiberglass layer occurs at the exact location as the damage on the outer fiberglass layer. In reality, cracking or breaking of the fiberglass casing is not typically concentrated in a one-panel area. In another sense, there is increased resistance against natural elements that may leak through the external cladding. For example, rainwater seeping through may touch the outer fiberglass layer, but the Styro-aircrete is left untouched due to an inner fiberglass layer. In another example, the outer fiberglass layer of a roof panel may be damaged, and water leaks through the outer fiberglass layer. However, the inner fiberglass layer can still protect the Styro-aircrete inside. The presence of two fiberglass layers also does not significantly add to the weight of the panel, allowing the product to be much lighter. The bilayer design provides the best benefit to disadvantage ratio solution.

In the third aspect of the present disclosure, the panel comprises a novel super-light Styro-aircrete composition that is Styrofoam (PVA) beads, making the panels very light but durable and serving as a load-bearing element of the building. The Styro-aircrete creation involves a composition or formula comprising multiple different ingredients and is made by mixing the ingredients in a specific process. The process begins with all the ingredients and equipment prepared. The ingredients are weighed before being added to a piece of equipment called a mixer. Specifically, for example, a bag of 94 pounds of Portland cement is first added to the mixer. 27.25 liters or 6 gallons of water is then prepared with 0.5 liter PVA glue before being added to the mixer; the Glycerin and foaming agent ensures that air bubbles are maintained during the Styro-aircrete formation. Then, 94 liters of generated high-density (90-100 gram or approximately 3 ounces per quart) foam and 204 liters of shredded Styrofoam are also added to the mixer. The shredded Styrofoam used is expanded polystyrene (EPS). The mixer then activates to mix everything, resulting in a chemical reaction that makes concrete with air bubbles (i.e., Styro-aircrete). The Styro-aircrete formula may allow each component amount to vary by roughly±20%.

A fiberglass frame from the first aspect is prepared with the following: (1) wire mesh(es) and fiberglass fibers arranged in a particular arrangement depending on the panel embodiment; (2) bilayer fiberglass sheets; (3) all sides of a rectangular prism fiberglass casing are enclosed except for one of the sides remains open. The concrete mixture is added to the frame from the only opening side. The whole thing is set aside for fourteen days before the Styro-aircrete is hardened and sealed with a fiberglass cover. Thanks to this composition, the Styro-aircrete panel becomes much lighter (up to ten times lighter) than existing products. Furthermore, this lighter weight allows for easy handling and rearrangement (if needed) during construction sites, where specialized equipment like cranes may no longer be needed to lift the panel. This new Styro-aircrete composition also hardens quicker than traditional Styro-aircrete products. This may be because shredded Styrofoam is used, and its aggregation assists with water being wicked away from the drying concrete, thereby reducing the curing time. Overall, the time needed for the formation, transport, or handling is reduced. It is also cheaper since more can be manufactured in a shorter time. No specialized equipment and training are needed to handle panels made with the novel Styro-aircrete composition.

In the fourth aspect of the present disclosure, at least one structured embedded wired mesh and fiberglass fibers is used to bind the Styro-aircrete structure together. The first aspect states that simple wire gauge meshes with fiberglass fibers are inserted into the fiberglass frame before pouring the Styro-aircrete mixture. The wire can be iron, steel, copper, or rigid plastic. The mesh can also be other non-wired sheets, such as fiberglass fiber sheets, linen sheets, tarp, gunny cloth, etc. Depending on the embodiment, at least one embedded wire mesh is used with various arrangements or shapes to enforce the panel's structural integrity. The mesh shapes and arrangements extend a significant part of the fiberglass's base sides.

In one embodiment, a simple wire mesh and fiberglass fibers sheet is added in the middle of a wall panel and covers the entire width and length of the panel. When the wall panel lies flat with the larger base sides facing the top and bottom, this wire mesh sheet is situated in the middle along the transverse plane. On the other hand, if the wall panel is upright with one lateral side at the bottom, the wire mesh sheet is in the middle along the frontal plane. In another embodiment as an exemplary roof panel, four wire mesh sheets are arranged, connected, and embedded to form a rectangular-shaped grid; each wire mesh sheet of this grid faces a lateral side of the fiberglass frame. In yet another embodiment as an exemplary support beam building block, three wire meshes and fiberglass fibers are arranged in the middle of the panel to form a triangular wire mesh grid that runs along the length of the panel's lateral faces. Additional wire mesh sheets are embedded within the beam on the lateral sides of the triangular wire mesh grid; the wire mesh sheets are arranged in the middle of the panel along the transverse plane when one of the beam's longer lateral faces is lying flat and acting as the beam's bottom side. To the ordinarily skilled in the art, other mesh shapes and arrangements beyond the above examples can also be possibly used. Thanks to the arrangement of the meshes inside the Styro-aircrete panel designs, the structural integrity of the panel is maintained even if the Styro-aircrete begins to crack internally. More specifically, the wire meshes and fiberglass fibers keep little pieces of any cracked Styro-aircrete in place, preventing them from shifting around and compromising the panel's core structure. Essentially, the meshes increase the durability of the panel, preventing the collapse of the entire structure. The meshes also provide extra panel strength, as they maintain the panel's core structure when the panel is used for load-bearing support.

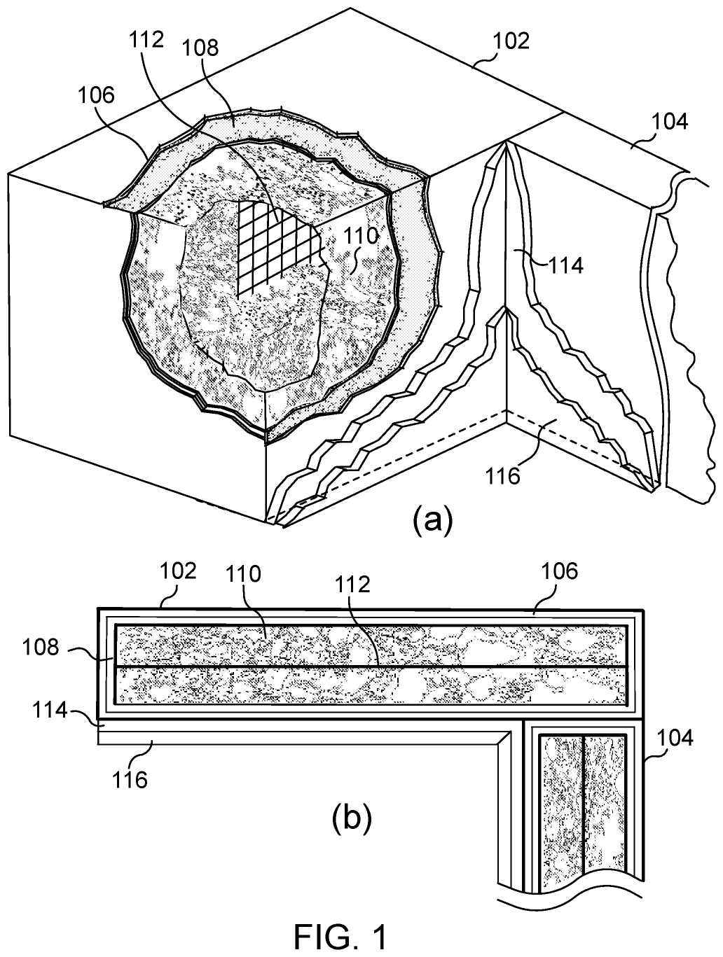

FIG. 1 illustrates perspective and top views of two wall panels in one embodiment of the present disclosure. Sub-figure (a) illustrates a perspective view of two wall panels in one embodiment of the present disclosure. A rectangular exemplary wall panel (102) is shown on the left side of the sub-figure, standing upright with an exemplary length, width, and height. To show the internal structure of the panel more clearly, Sub-figure (a) illustrates the panel (102) in little exaggerated dimensions that look close to a cube, while those, in reality, should look like a thinner flat panel shape. The base of the exemplary wall panel (102) pointing to the bottom-right faces the interior building space and is considered an ‘interior-facing side’. An adjacent wall panel (104) is situated on the right side of the sub-figure and is perpendicular to the exemplary wall panel (102). The adjacent wall panel (104) is situated perpendicular to the right corner of the interior-facing side of the exemplary wall panel (102). The adjacent wall panel (104) stands upright with a different length and width but the same height as the exemplary wall panel (102). The larger bases face the bottom-left and upper-right sides, while the lateral sides face the top, middle-right, bottom, and middle-left sides. The interior-facing side of the adjacent wall panel (104) is facing the bottom left.

Additionally, the upper-right sides of both wall panels (102, 104) are aligned side-by-side. The arrangement of the wall panels (102, 104) appears to form a reverse P-shape formation. The interior facing sides of the wall panels (102, 104) are bound together with a fiberglass binding layer (114), which is then covered with internal cladding (116).

The exemplary wall panel (102) on the left is primarily made with Styro-aircrete (110). A bilayered fiberglass casing (106, 108) encases all sides of the exemplary wall panel's (102) Styro-aircrete (110). As the name implies, the term bilayered referred here means a structure of two layers of material layered immediately to each other. The bilayered fiberglass casing (106, 108) had two layers: a first or outer fiberglass layer (106) acts as the external surface of the entire exemplary wall panel (102); a second or inner fiberglass layer (108) encases the Styro-aircrete (110) of the exemplary wall panel (102). This is why the structure sometimes is also called double encapsulation. An embedded wire mesh sheet (112) and fiberglass fibers layer is embedded within the Styro-aircrete (110).

It is obvious to those ordinarily skilled in the art that the adjacent wall panel (104) comprises the same composition of components as the exemplary wall panel (102); this will be shown in the next sub-figure.

The exemplary wall panel (102) and adjacent wall panel (104) are shown with different sizes and dimensions in the sub-figures. Specifically, the exemplary wall panel (102) is shown as a thicker panel in length and width. However, such sizes and dimensions for both wall panels (102, 104) are mainly for illustrative purposes; it is obvious to those ordinarily skilled in the art that the wall panels (102, 104) can be of any width, length, and height depending on the embodiment and the application thereof. For example, the dimensions of the exemplary (102) and adjacent (104) wall panels may be reversed in sub-figure (a), with the adjacent wall panel (104) being longer and wider than the exemplary wall panel (102). In another exemplary embodiment, the exemplary (102) and adjacent (104) wall panels have equal lengths, widths, and heights; this will be shown in the next sub-figure.

Sub-figure (b) illustrates a top view of the two wall panels in one embodiment of the present disclosure. The larger faces/sides or bases point to the bottom and top for the exemplary wall panel (102), while the bases of the adjacent wall panel (104) face left and right. The lateral sides of both wall panels (102, 104) point to the sides not mentioned in the previous sentence. All descriptions of the wall panel (102, 104) components in the previous sub-figure apply here. The inner fiberglass layer (108) completely encases the Styro-aircrete (110) and embedded wire mesh sheet (112) and fiberglass fibers of the wall panels (102, 104). The outer fiberglass layer (106) completely envelopes the inner fiberglass layer (108) and the rest of the contents therein. The embedded wire mesh sheet (112) and fiberglass fibers are situated in the middle of each panel (102, 104) as a single sheet layer. The embedded wire mesh sheets (112) and fiberglass fibers are situated along the frontal plane of the wall panels (102, 104) at an upright orientation. Looking at the sub-figure, the embedded wire mesh sheets (112) appear to separate the Styro-aircrete (110) into two sections with each wall panel (102, 104). The fiberglass binding layer (114) is shown as a single sheet that covers and attaches two wall panels (102, 104). The fiberglass binding layer (114) attaches to the interior-facing sides of the wall panels (102, 104); looking at the sub-figure, the bottom side of the exemplary wall panel (102) and the left side of the adjacent wall panel (104) are those interior-facing sides. Two individual internal cladding (116) pieces are attached in front of the fiberglass binding layer (114): one in front of the 365 exemplary wall panel (102) and another in front of the adjacent wall panel (104).

The figure shows a general overview of multiple aspects that improve existing Styro-aircrete products. The panels (102, 104) have increased durability, increasing their lifespan. Thanks to the bilayered fiberglass casing (106, 108) and the embedded wire mesh sheets (112). The bilayered fiberglass casing (106, 108) covers all six sides of the panel (102, 104). As cracks may form over time, they do so on the fiberglass casing (106, 108) rather than the Styro-aircrete (110) itself. Since there are two layers of fiberglass casing (106, 108), the outer fiberglass layer (106) would crack first. So, even if the outer fiberglass layer (106) breaks open, the inner fiberglass layer (108) will still completely protect the Styro-aircrete (110). It should also be noted that such damage (e.g., cracks) does not typically occur at one spot, which is further working in the fiberglass casings (106, 108) favors increased durability. Suppose, however, the Styro-aircrete (110) of the panel (102, 104) does crack, whether from external damage or internal damage. Any fractured pieces are kept in place by the embedded wire mesh sheet (112) and fiberglass fibers, preventing any shifting of said pieces. As a result, it reduces the likeliness of the whole panel collapsing.

The fiberglass casing (106, 108) also adds increased strength, mainly compressional strength. The outer fiberglass layer (108) acts as a sort of cushion for the panel (102, 104), which bolsters the innate compressional strength of the Styro-aircrete (110). So, since the Styro-aircrete (110) is not the part that directly takes on weight, it is less likely to crack or break. The wire mesh sheets (112) and fiberglass fibers also help with this compressional strength, allowing the panel's (102, 104) core structure to stay in one piece and prevent the shifting of potential pieces.

Fiberglass is used for the panel casing (106, 108) in the preferred embodiment of the present disclosure. This type of material is known to be light yet strong. So, in a minor sense, the bilayered fiberglass casing (106, 108) is light enough that it would not add significant weight to the panels (102, 104). However, the material used for this casing (106, 108) is non-limiting. It can be any other material in alternative embodiments, including polyester, carbon fibers, composite fibers, or a combination thereof.

The preferred embodiment shows two fiberglass layers (106, 108) for the fiberglass casing (106, 108). The use of two fiberglass layers (106, 108) is ideal for balancing panel (102, 104) strength, durability, and weight. However, the number of fiberglass layers (106, 108) is not limited to just two. In other embodiments, there can be three, five, or any number of fiberglass layers (106, 108). However, adding additional fiberglass layers (106, 108) may affect the panel's weight, size, and handling (102, 104) as a whole, despite the fiberglass's light weight. Moreover, the thickness of each fiberglass layer (106, 108) may need to be thinner if several fiberglass layers (106, 108) are used to create a certain size for the wall panel (102, 104). In another alternative embodiment, only one fiberglass layer (106, 108) may be used; however, this will affect the strength and durability of the wall panel (102, 104). In yet another embodiment of the present disclosure, certain sides may have two fiberglass layers (106, 108), while others may have one fiberglass layer (106, 108).

The fiberglass layers (106, 108) are shown to be equal in thickness on all sides; however, the thickness of both fiberglass layers (106, 108) may differ in other alternative embodiments. In one alternative embodiment, both the outer (106) and inner (108) fiberglass layers are thicker, which could result in increased durability and strength for the wall panel (102, 104). In another alternative embodiment, the wall panel (102, 104) has a very thick outer fiberglass layer (106) and a thinner fiberglass layer (108).

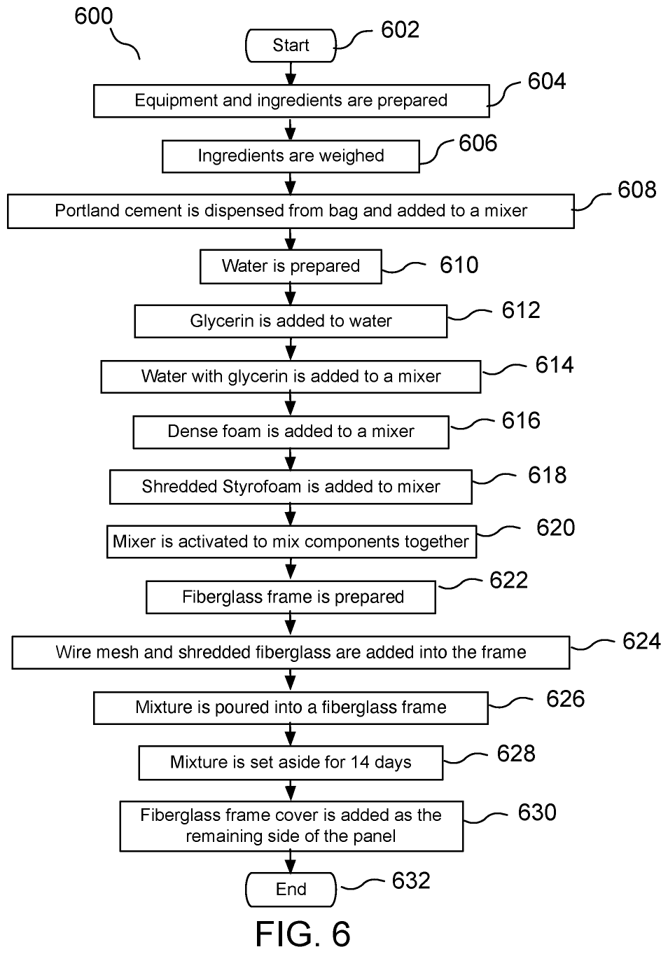

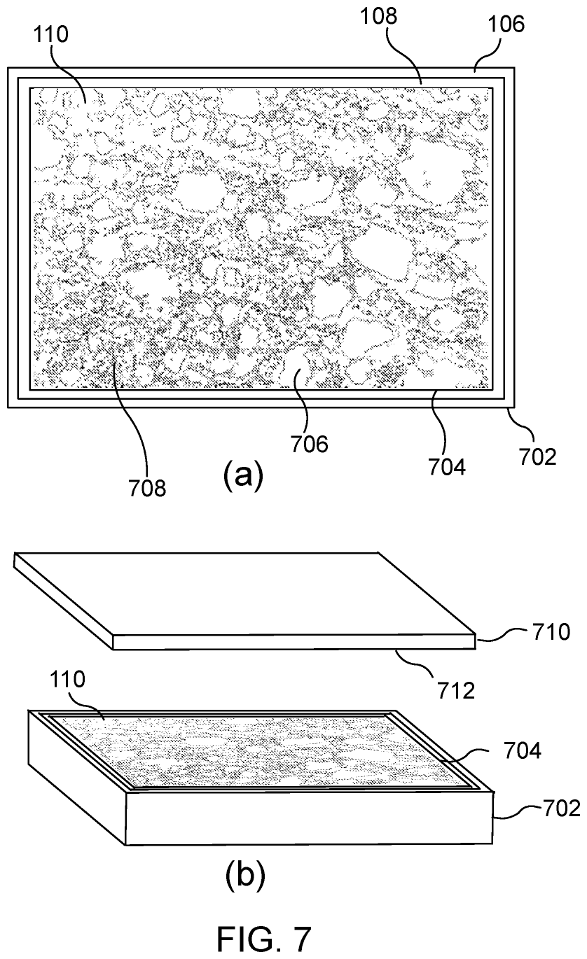

It should be noted that the fiberglass casing (106, 108) comprises a panel frame and fiberglass cover, which allows for the complete protection of the panel. This will be further shown and explained in FIGS. 6 and 7.

The figure also shows the Styro-aircrete (110) aspect of the present disclosure, comprising foam aggregate pieces (i.e., shredded Styrofoam and dense foam) and air bubbles. Because of its unique composition, it is much lighter than existing Styro-aircrete products. This aspect will be further shown and explained in FIGS. 6 and 7.

It is obvious to those ordinarily skilled in the art that the Styro-aircrete (110) sections shown in sub-figure (b) are a result of the Styro-aircrete (110) permeating through the embedded wire mesh sheet (112) before drying.

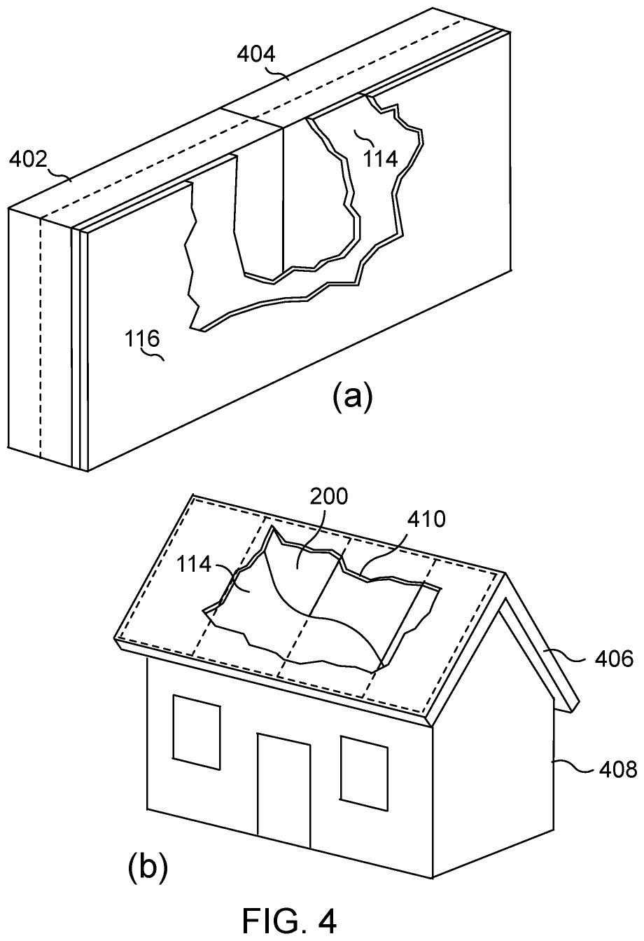

The exemplary wall panel (102) and adjacent wall panel (104) are aligned with one being perpendicular to the other. A shorter lateral side of the adjacent wall panel (104) is situated on the interior-facing side of the exemplary wall panel (102) at the bottom right. However, the arrangement of wall panels (102, 104) is not limited to this arraignment. In some alternative embodiments, the adjacent wall panel (104) can be aligned perpendicularly along the middle or bottom-left of the exemplary wall panel. In alternative embodiments, the adjacent wall panel (104) can be aligned perpendicularly to the opposite side (exterior-facing side) of the exemplary wall panel (102). In another alternative embodiment, the two wall panels (102, 104) can be side-by-side with the same orientation, as shown in FIG. 4.

The number, size, and positioning of the wire mesh sheet (112) and fiberglass fibers within the wall panels (102, 104) can vary depending on the embodiment. In one such embodiment, the wire mesh sheet (112) can be smaller and localized at the center of the wall panel (102, 104). In another embodiment, there can be three wire mesh sheets within the wall panels (102, 104): one next to the interior-facing side, one in the middle, and one next to the exterior-facing side.

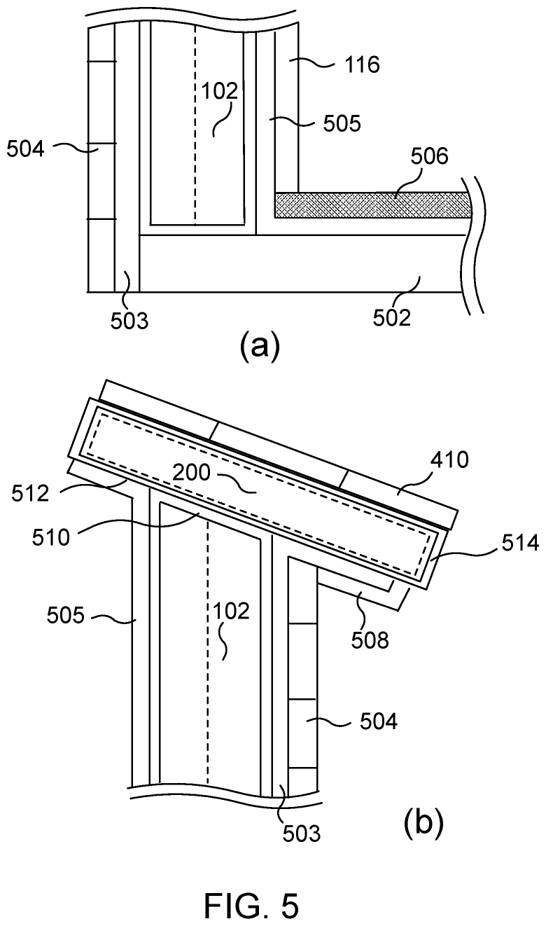

Although the fiberglass binding layer (114) is not officially an aspect in the present disclosure, it is an important integrated step for building a structure with the panels (102, 104). Additionally, the fiberglass binding layer (114) is shown between two adjacent wall panels (102, 104); however, those ordinarily skilled in the art may find it obvious that the fiberglass binding layer (114) can efficiently attach panels at different orientations. The application of the fiberglass binding layer (114) will be shown further in FIGS. 4 and 5.

The internal cladding (116) can comprise a non-limiting list of materials used as the inner wall. Depending on the embodiment, drywall panels, hardwood panels, bricks, or any suitable material can be added to the wall panel's (102, 104) fiberglass binding layer (114). In another embodiment, only paint is applied to the wall panel (102, 104).

In yet another alternative embodiment, iron rebar can be used within the Styro-aircrete (110) of the wall panel (102, 104) to reinforce the structural integrity further. However, this may make the panel (102, 104) heavier and compromise the embedded wire mesh sheet (112).

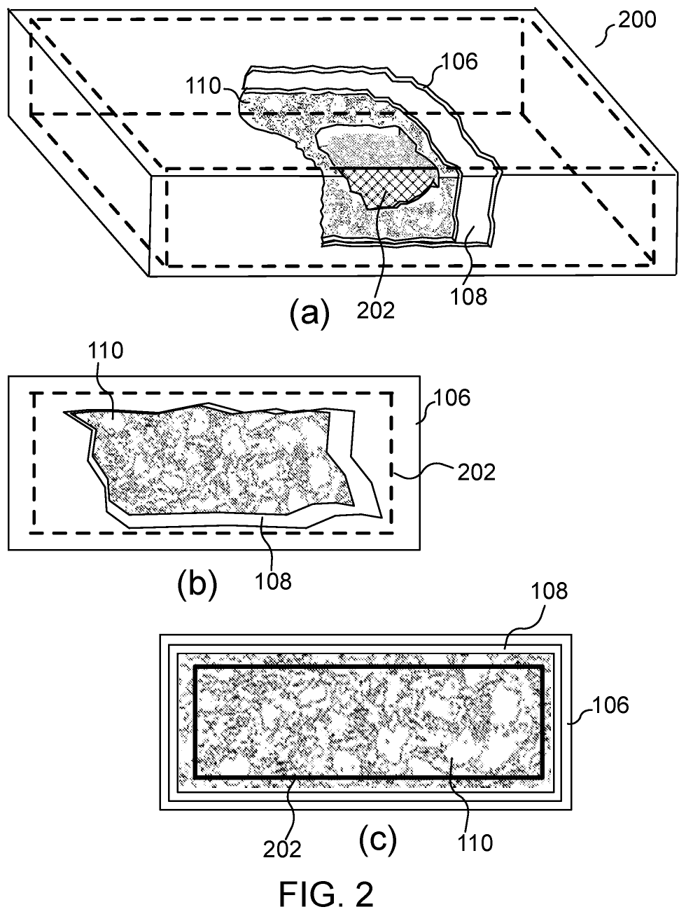

FIG. 2 illustrates perspective, cross-section, and top views of a roof panel in a preferred embodiment of the present disclosure. Sub-figure (a) illustrates a perspective view of a roof panel (200) in one embodiment of the present disclosure. Looking at the sub-figure, the roof panel (200) is lying flat, so the larger faces/sides or bases make up the top and bottom sides of the roof panel (200). The shorter lateral faces/sides face the front, the left, the right, and the rear. The roof panel (200) shares many similar components with the wall panel; all descriptions of the outer fiberglass layer (106), inner fiberglass layer (108), and Styro-aircrete (110) from the previous figure also apply here. A wire mesh is shown along the front lateral face of the roof panel (200); however, each lateral face/side of the roof panel (200) has a wire mesh that collectively forms an embedded rectangular wire mesh grid (202) within the roof panel (200).

Sub-figure (b) illustrates a top view of the roof panel (200) in one embodiment of the present disclosure. All descriptions of the roof panel (200) components mentioned in the previous sub-figure apply here. A portion of the outer fiberglass layer (106) on the top side is opened to reveal an open portion of the inner fiberglass layer (108) and Styro-aircrete (110). The rectangular wire mesh grid (202) is shown aligned with the edges of the roof panel (200).

Sub-figure (c) illustrates a cross-section view of the roof panel (200) in one embodiment of the present disclosure. All descriptions of the roof panel (200) components mentioned in the previous sub-figures apply here. The roof panel (200) is still oriented in the same way as in sub-figure (b), so the cross-section is made along its transverse plane. Essentially, this view is considered a top cross-sectional view. The inner (108) and outer (106) fiberglass layers are shown to have equal thickness. The Styro-aircrete (110) is split into two sections separated by the rectangular wire mesh grid (202).

It is obvious to those ordinarily skilled in the art that the Styro-aircrete (110) sections shown in sub-figure (c) are a result of the Styro-aircrete (110) permeating through the rectangular wire mesh grid (202) before drying. It is also obvious to those ordinarily skilled in the art that a form of roof covering (e.g., shingles) would be applied on top of the roof panel (200); this will be further shown in FIGS. 4 5.

The roof panel (200) is shown with a fixed size with fixed dimensions in the sub-figures. However, the size shown for the roof panel (200) is mainly for illustrative purposes; it is obvious to those ordinarily skilled in the art that the roof panel (200) can be of any width, length, and height depending on the embodiment.

Although the wire meshes and fiberglass fibers are arranged differently to form the rectangular wire mesh grid (202) for a roof panel (200), the mesh grid (202) still serves the same purpose of keeping the Styro-aircrete (110) in place if a crack forms in the roof panel (200) to prevent any shifting of Styro-aircrete (110) pieces. The rectangular wire mesh grid (202) is shown with a fixed size close to the dimensions of the roof panel (200). However, it should be noted that the rectangular wire mesh grid (202) can be of any size with any combination of dimensions in other embodiments. For example, the rectangular wire mesh grid (202) can be smaller to encircle a smaller area like the central part of a roof panel (200). The ratio of Styro-aircrete (110) separated by the rectangular wire mesh grid (202) would be different, although the amount of Styro-aircrete (110) within the roof panel (200) itself would not change. It should also be noted that the arrangement of wire meshes and fiberglass fibers that form the rectangular wire mesh grid (202) is not limited to what is shown in the figure. In one alternative embodiment, a single wire mesh sheet may be arranged within a roof panel (200) in the same way as a wall panel.

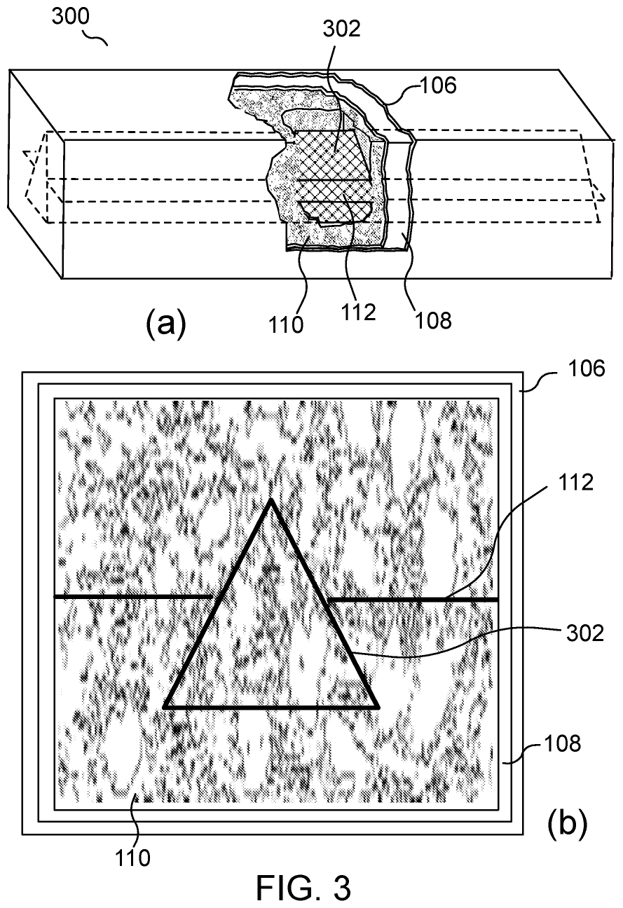

FIG. 3 illustrates perspective and cross-section views of a beam in one embodiment of the present disclosure. Sub-figure (a) illustrates a perspective view of a beam (300) in one embodiment of the present disclosure. Looking at the sub-figure, the beam (300) is lying flat as a square prism; the rectangular lateral sides make up the top, bottom, front, and rear sides of the beam (300), while the square faces or bases are facing the left and right sides. The beam (300) shares many similar components with the wall panel and roof panel; all descriptions of the outer fiberglass layer (106), inner fiberglass layer (108), and Styro-aircrete (110) from the previous figures also apply here. Three wire meshes and fiberglass fibers form a triangular mesh grid (302) in the middle of the beam (300), which extends along the length of the beam's (300) lateral faces, which are left to right in the sub-figure. Two embedded wire mesh sheets (112) are located next to the triangular mesh grid (302), which are also aligned with the beam's (300) lateral faces (left to right).

Sub-figure (b) illustrates a cross-section view of a beam (300) in one embodiment of the present disclosure. All descriptions of the beam (300) components mentioned in the previous sub-figure apply here. The cross-section is made at the beam's (300) base along the frontal plane. The inner (108) and outer (106) fiberglass layers are equal thickness. The triangular wire mesh grid (302) is in the shape of an upward triangle. The embedded wire mesh sheets (112) at the peripheral sides of the triangular wire mesh grid (302) are situated in the middle of the beam (300).

The beam (300) is shown with a fixed size and dimensions in the sub-figures. However, the size shown for the beam (300) is mainly for illustrative purposes; it is obvious to those ordinarily skilled in the art that the beam (300) can be of any width, length, and height depending on the embodiment.

The triangular wire mesh grid (302) and wire mesh sheets (112) are combined to increase the durability of the beam (300) in the same way as the embedded wire meshes and fiberglass fibers of the wall and roof panels. Both of the beam's (300) wire meshes and fiberglass fibers (112, 302) are shown with a fixed size within the beam (300). However, it should be noted that each triangular wire mesh grid (202) and wire mesh sheet (112) can be of any size with any combination of dimensions in other embodiments. For example, the beam's (300) wire meshes and fiberglass fibers (112, 302) can be smaller. For example, in one alternative embodiment, the triangular wire mesh grid (202) does not extend along the length of the beam's (300) lateral sides.

The wire mesh sheets (112) and triangular wire mesh grid (302) can also be situated at any position above or below the middle of the beam (300) in other alternative embodiments. The wire meshes and fiberglass fibers (112, 302) can be located near the top or bottom of the beam (300). In other alternative embodiments, the wire mesh sheets (112) can be positioned above or below the triangular wire mesh grid (302). In yet another alternative embodiment, the wire mesh sheets (112) can be perpendicular to one another.

FIG. 4 illustrates the use of a fiberglass binding layer on two wall panels and two roof panels. Sub-figure (a) illustrates the use of a fiberglass binding layer (114) on two wall panels. Two wall panels, a first alternative wall panel (402) and a second alternative wall panel (404), are standing upright side-by-side. The first alternative wall panel (402) is on the bottom-left side, and the second alternative wall panel (404) is on the top right side. The interior-facing sides of both alternative wall panels (402, 404) face the right side of the sub-figure. A single sheet of fiberglass binding layer (114) covers both alternative wall panels (402, 404) on their interior-facing sides. Internal cladding (116) is then applied onto the fiberglass binding layer (114).

It should be noted that the alignment of the wall panels (402, 404) is not limited to the arrangement shown in the sub-figure. In one alternative embodiment, the first alternative wall panel (402) is perpendicularly connected along one end of the second alternative wall panel (404), forming an L-shape between the two wall panels (402, 404). In another alternative embodiment, the first alternative wall panel (402) is perpendicularly connected to the middle of the second alternative wall panel (404), forming a T-shape between the two wall panels (402, 404).

Sub-figure (b) illustrates the use of a fiberglass binding layer on two roof panels. The roof (406) on top of a house (408) comprises individual roof panels (200); in this sub-figure, four roof panels (200) are sloped along the one side of the roof (406) above the front side of the house (408). A single fiberglass binding layer (114) covers all four roof panels (200) on one side of the roof (406). A roof covering (410) is placed on top of the fiberglass binding layer (114) and roof panels (200).

The sub-figure shows roof panels (200) as part of a pitched roof (406) on top of a detached residential house (408), which is the most common situation where the present disclosure may apply. However, the roof (406) and house (408) shown in the sub-figure are exemplary and are not limited to just one type of roof (406) and building, respectively. In one alternative embodiment, the roof panels (200) can be used for high-rise condominium buildings with flat roofs (406). In another alternative embodiment, the roof panels (200) may form a single roof (406) on top of multiple attached townhouses. In yet another alternative embodiment, the roof panels (200) may form a main roof (406) on top of a house (408) with a secondary roof (406) separated by roof (406) valleys. A roof (406) valley is where the slopes of two roofs (406) intersect. It should be noted that the shape of a roof panel (200) around the valleys would need to be modified for a seamless fit.

It should also be noted that the number of roof panels (200) used to cover a roof (406) is non-limiting; there can be two, eight, or any number of roof panels (200) that make up the roof (406). This would depend on the size of the house (408) or building, its roof (406), and the size of each roof panel (200).

The type of roof covering (410) that covers both the roof panels (200) and the fiberglass binding layer (114) can be any type of roofing material, depending on the embodiment. Examples of common roof coverings (410) include shingles, steel roof panels, clay roof tiles, etc.

The fiberglass binding layer (114) in the figure is used as an integrated step in efficiently binding two or more wall panels (402, 404) or roof panels (200) together. However, the building panels (200, 402, 404) attached to one binding layer (114) do not have to be of the same type; this will be shown further in FIG. 5.

FIG. 5 illustrates side cross-section views of a wall panel attaching to a floor slab and roof panel. Sub-figure (a) illustrates a side cross-section view of a wall panel (102) attaching to a floor slab (502). A wall panel (102) is positioned upright and perpendicular to the floor slab (502). Two fiberglass binding layers (503, 505) are applied onto the wall panel (102) and floor slab (502): an exterior-facing fiberglass binding layer (503) is applied onto the wall panel (102) and floor slab (502) facing the external elements, shown on the left of the sub-figure. The exterior-facing fiberglass binding layer (503) section next to the wall panel (102) is covered with external cladding (504); an interior-facing fiberglass binding layer (505) is applied onto the wall panel (102) and floor slab (502) within the building interior, shown on the right side of the sub-figure. The interior-facing fiberglass binding layer (505) bends at a right angle (90 degrees), where the bottom of the wall panel (102) intersects with the top of the floor slab (502). A floor topping (506) is applied on top of the horizontal section of the interior-facing fiberglass binding layer (505) above the floor slab (502). Interior cladding (116) is applied on the vertical section of the interior-facing fiberglass binding layer (505) next to the wall panel (102).

The floor topping (506) is not limited to one type of flooring material. Depending on the embodiment, the floor topping (506) can be carpet, ceramic tile, hardwood, or other flooring material. It should also be noted that the height of the floor topping (506) may also vary depending on the embodiment.

Sub-figure (b) illustrates a side cross-section view of a wall panel (102) attaching to a roof panel (200). A wall panel (102) is positioned upright with a tilted top wall panel side (510) to accommodate the pitch of a downward-sloping roof panel (200). The top wall panel side (510) is tilted downward from the upper-left to the bottom-right. An exterior-facing fiberglass binding layer (503) attaches to the external-facing side of the wall panel (102) and the bottom roof panel side (512) underneath the front-facing roof panel side (514), which are shown on the right side of the sub-figure. Part of the exterior-facing fiberglass binding layer (503) bends at an angle to accommodate the intersecting point of the wall panel (102) and the roof panel (200). External cladding (504) is placed on the exterior-facing fiberglass binding layer (503) on the right side of the wall panel (102). A soffit (508) is installed directly on the bottom roof panel side (512) underneath the front-facing roof panel side (514); the soffit (508) also covers part of the exterior-facing fiberglass binding layer (503) at the same roof panel sides (512, 514). An interior-facing fiberglass binding layer (505) is attached to the wall panel's (102) interior-facing side on the left side of the sub-figure, also covering the upper-left side of the roof panel (200) at the bottom roof panel side (512). The interior-facing fiberglass binding layer (505) bends at an angle where the interior-facing side of the wall panel (102) and the roof panel (200) intersect. Roof covering (410) is attached to the top side of the roof panel (200).

As noted before, the fiberglass binding layer (503, 505) serves as an important component as an integrated step in a building's formation. A single sheet of the fiberglass binding layer (503, 505) can be used to attach two Styro-aircrete panels of the same type (e.g., wall panel (102) to wall panel (102)), two different types of Styro-aircrete panels (e.g., roof panel (200) and wall panel (102)), or one Styro-aircrete panel (e.g., wall panel (102)) to a non-Styro-aircrete building element (e.g., floor slab). The fiberglass binding layer (503, 505) can attach to adjacent corners created by the intersection of perpendicular building panels (102, 200). In a sense, the binding layer (503, 505) can be used to save costs and time, becoming an intra-goal of being the most efficient way of assembling the building panels (102, 200). The fiberglass binding layer (503, 505) can also reduce costs and time since a single sheet of fiberglass binding layer (503, 505) can cover a much larger surface on one side of a building (i.e., interior and exterior sides). That way, it reduces the amount of unneeded or wasted materials. Applying the fiberglass binding layer (503, 505) can be done in one action rather than repeatedly applying one binding layer (503, 505) sheet at a time. The fiberglass binding layer (503, 505) could also serve as an extra layer of protection, further increasing the durability of the building panels (102, 200). It should be noted that this also applies to beams attached to the building panels (102, 200).

The fiberglass interior-facing (505) and exterior-facing (503) binding layers can be inserted onto the building panels (102, 200) using various fastening methods. Depending on the embodiment, the binding layer (503, 505) can be fastened onto the building panels (102, 200) and floor slab (502) with nails, screws, adhesives, snap-fit mechanisms, etc.

The top wall panel side (510) is slanted to accommodate the downward slope of the roof panel (200), sloping from the top left to the bottom right. It should be noted that the direction and angle of the sloping for the top wall panel side (510) may vary depending on the embodiment. In one such embodiment, the top wall panel side (510) is flat to accommodate a roof panel (200) for a flat roof.

One layer of fiberglass binding layer (503, 505) is shown to cover the wall panel (102), roof panel (200), and floor slab (502). In other embodiments, more than one fiberglass binding layer (303, 305) can be attached to the aforementioned building elements (102, 200, 502). However, more material is used up, and more time is needed to install additional fiberglass binding layers (503, 505).

FIG. 6 illustrates a flowchart of a preferred embodiment of the super-light Styro-aircrete manufacturing details of the present disclosure. The process (600) starts at (602). The Styro-aircrete ingredients and the necessary equipment are gathered at step (604); the equipment at step (604) primarily comprises a mixer. The Styro-aircrete ingredients are weighed at step (606). Once weighed (606), an appropriate amount of 94 pounds of Portland cement is dispensed from a bag and added to the mixer at step (608). 27.25 liters of water is prepared with 0.5 liter PVA glue and added to the mixer at step (610). Glycerin and foaming agent are added to the water at steps (612, 614), respectively. Glycerin, foaming agent, and water start to generate dense foam. The high-density foam weight should be between 90-100 grams or approximately 3 ounces per quart. If the foam is heavier, it should increase the air pressure, or if the foam is lighter, it should decrease air pressure. After this, ninety-four liters of said dense foam are then added to the mixer at step (616). Two hundred four liters of shredded Styrofoam are then added to the mixer at step (618). The mixer is activated to mix all the aforementioned components at step (620). The Styro-aircrete formula may allow each component amount to vary by ±20%. A fiberglass panel frame is prepared at step (622), either during or after the mixing at step (620). At step (624), wire mesh(es) and shredded Styrofoam are added to the panel frame. When the mixture is complete, it is then poured into the fiberglass frame at step (626). The mixture is then set aside to dry and harden for fourteen days (628). After fourteen days, a fiberglass frame cover is added on top of the remaining exposed side of the panel at step (630), sealing the hardened Styro-aircrete mixture inside the fiberglass casing. The process (600) ends at step (632).

Thanks to the process (600), a building panel can be much lighter than existing products. The shredded Styrofoam and the dense foam act as lightweight aggregates for the core structure and most volume of the Styro-aircrete. Shredded Styrofoam is practically 98% air, so it is much lighter as an aggregate than the stones used in traditional concrete. The shredded Styrofoam also helps create air bubbles within the Styro-aircrete; further in the next figure will be mentioned. The Glycerin in the water at step (612) ensures that the air bubbles are maintained during the whole Styro-aircrete formation process (600). Ultimately, the density of the whole panel is reduced, making the panel very lightweight. The bilayered fiberglass panel frame with a cover and the wire meshes and fiberglass fibers help ensure increased strength and durability without adding significant weight to the panel.

At step (614), the foaming agent is added to the water directly. However, the foaming agent is not limited to being added to the mixture in this way. In one alternative embodiment, the foaming agent can be added to Glycerin first, then the formed mixture is added to the mixer.

The Styro-aircrete in the preferred embodiment of the present disclosure can also be made more quickly and cheaply than existing concrete products, effectively saving time. Existing concrete products take about 21 to 28 days to harden. On the other hand, as stated in step (628), the novel Styro-aircrete takes fourteen days to cure. This reduction in the drying time is due to the shredded Styrofoam and other components playing a role in wicking away water within the Styro-aircrete mixture. The process of the Styro-aircrete is straightforward, making it less expensive to carry out with no significant training or equipment needed. The novel Styro-aircrete can be made quickly, which means more can be made in a shorter time.

Although fourteen days would be the minimum for the novel Styro-aircrete to harden, it can be left for longer periods in alternative embodiments. This would likely require adding different volumes and ratios of the formula's ingredients into the mixture. For example, a different volume of shredded Styrofoam, dense foam, or shredded fiberglass can be added at steps (616, 618, 624) in other alternative embodiments during the Styro-aircrete formation process (600). In such a case, the modified volumes of the noted materials would affect the drying time for the mixture.

Portland cement (94 pounds) is one type of cement used to make Styro-aircrete in the preferred embodiment. This type of cement is a hydraulic cement, which hardens with the addition of water. Different types of hydraulic Portland cement may be used depending on the embodiment. Examples of various types of Portland cement that can be used include: high early strength, high sulfate resistance, low heat hydration, etc. In one such embodiment, rapid-hardening cement can be used to further reduce time in the Styro-aircrete formation process (600).

In other alternative embodiments, other types of Portland cement may be used. For example, one alternative embodiment may use a non-hydraulic cement, which reacts with carbon dioxide as it dries. This further reduces the materials needed, such as the water and Glycerin from steps (610, 612, 614); however, this may affect the weight, strength, and durability of the Styro-aircrete made with such cement.

The Styro-aircrete in other embodiments may add additional materials such as sand, lime, additional aggregates, etc. In another alternative embodiment, the core Portland cement can be entirely replaced with fly ash. However, changing the composition of ingredients within the process (600) in such a manner may affect the structural integrity, weight, and setting time for the Styro-aircrete formation.

FIG. 7 illustrates top cross-section and exploded perspective views of the super-light Styro-aircrete of the present disclosure. Sub-figure (a) illustrates a top cross-section view of the super-light Styro-aircrete of the present disclosure. The outer (106) and inner (108) fiberglass layers make up a fiberglass panel frame (702) in the shape of a standard panel with a frame opening (704) accessible from the top side of the frame (702); both outer (106) and inner (108) fiberglass layers have an equal thickness in the preferred embodiment. But they can also have a different thickness in other embodiments. Styro-aircrete (110) is poured into this frame opening (704), where it will harden. The Styro-aircrete (110) comprises several foam aggregate pieces (706) and air bubbles (708), both of which vary in size and quantity within the panel frame (702).

Although the panel in the preferred embodiment is made with Styro-aircrete (110), other lightweight concretes may also be used in other alternative embodiments of the present disclosure. In one alternative embodiment, a lightweight aggregate concrete may be used instead, made with porous aggregates like clay, shale, slate, ash, etc. This type of concrete has high insulation but may have low strength. In another exemplary embodiment, No-Fines concrete can be used for the building panel, formed using large, coarse aggregates. In addition to its light weight, No-Fines concrete is more economical, has high insulation, resists rain due to the minimal capillary action, and resists drying shrinkage. However, like lightweight aggregate concrete, No-Fines concrete has lower strength, particularly compressive, flexural, and bond strength.

The foam aggregate (706) comprises shredded Styrofoam and high-density foam from the Styro-aircrete manufacturing process in the previous figure. Both types of foam aggregate (706) help form the core structure of the Styro-aircrete (110). Additionally, the shredded Styrofoam pieces are made of expanded polystyrene (EPS), taking on the form of small, lightweight balls that are about 98% air. Furthermore, these EPS foam aggregate pieces (706) are key in making the Styro-aircrete (110) super-light. In addition to being part of the core structure (which is lighter than traditional stone), the EPS foam aggregate pieces (706) contain the foaming agent that triggers the creation of the air bubbles (708). The foaming agent most commonly found in EPS is pentane, a hydrocarbon that evaporates upon a temperature increase due to mixing the Styro-aircrete (110) ingredients. The EPS foam aggregate pieces (706) then expand in size within the Styro-aircrete (110).

However, it should be noted that the foam aggregate pieces (706) are not limited to just EPS and high-density foam; different types of foam may be used in their place depending on the embodiment. Examples of such foams in other embodiments include polyurethane foam, polyether foam, polyester foam, extruded polystyrene (XPS), etc.

The amount of foam aggregate Styro-aircrete pieces (706) and air bubbles (708) in this FIG. appears to be fairly equal within the Styro-aircrete (110). Several air bubbles (708) are present in the Styro-aircrete (110) thanks to the Glycerin added to the mixture. As noted earlier, the Glycerin increases the stability of the air bubbles (708) formed. Without it, many of the air bubbles (708) that do form during the Styro-aircrete (110) formation would be lost, which affects the weight and structural properties of the Styro-aircrete (110).

It should be noted that the number of air bubbles (708) or foam aggregate pieces (706) within the Styro-aircrete (110) may vary depending on the embodiment. In one such embodiment, there may be fewer air bubbles (708) due to less Glycerin being added to the mixture. In another embodiment, fewer foam aggregate pieces (706) may be added, affecting the Styro-aircrete novel composition (110). It should also be noted that the foam aggregate pieces (706) and air bubbles (708) are not limited to set sizes or diameters and can vary in other alternative embodiments.

The dispersion of the air bubbles (708) and foam aggregate pieces (706) appears to be random as a result of the Styro-aircrete (110) being mixed with a concrete mixer. However, the distribution of air bubbles (708) and foam aggregate pieces (706) may vary depending on the embodiment. For example, the Styro-aircrete (110) is manually mixed in one alternative embodiment. In another alternative embodiment, the ingredients are added in a different order. As a result, there may be clumped pockets of air bubbles (708) or foam aggregate pieces (706), where all the air bubbles (708) may be clumped on one side of the panel, while the foam aggregate pieces (706) are clumped on another panel side.

Sub-figure (b) illustrates an exploded view of the super-light Styro-aircrete of the present disclosure. All descriptions of the fiberglass frame (702), fiberglass frame opening (704), and Styro-aircrete (110) from the previous sub-figure also apply here. The Styro-aircrete (110) is left to dry and harden for fourteen days. After that, a fiberglass frame cover (710) is placed on top of the panel frame (702) to seal the entire Styro-aircrete panel; the bottom cover side (712) touches the top exposed side of the panel frame (702), and the frame opening (704), and the exposed Styro-aircrete (110).

It is obvious to those ordinarily skilled in the art that the fiberglass frame cover (710) would be bilayered like the panel frame (702). It is also obvious to those ordinarily skilled in the art that the process shown in this figure can be applied to any type of building panel like a wall panel, roof panel, or beam. As a result, the fiberglass frame (702) and fiberglass frame cover (710) can be any size depending on the embodiment and the type of panel being produced; however, the fiberglass frame cover (710) and the exposed side of the fiberglass frame (702) must have equal lengths and widths for a seamless fit.

The means for securing the fiberglass frame cover (710) onto the frame (702) may vary depending on the embodiment and is not limited to one type. In such alternative embodiments, various fasteners, such as nails, screws, snap-fit mechanisms, adhesives, magnets, or any other fasteners, may be used to secure the fiberglass frame cover (710) onto the frame (702).

The fiberglass frame cover (710) and fiberglass panel frame (702) have a very small gap at the point of intersection. It is obvious to those ordinarily skilled in the art that a sealant may be added along the intersecting edges to ensure that the Styro-aircrete (110) is completely sealed from moisture and any potential damage (e.g., cracking). Standard caulking may be used as a sealant for this gap in one such embodiment.

The size of the fiberglass frame opening (704) may also vary depending on the embodiment. The frame opening (704) can be smaller with a shallower depth in one such embodiment. This would make the fiberglass panel frame (702) and the associated inner (108) and outer (106) fiberglass layers thicker. However, suppose less Styro-aircrete (110) is added to the panel frame (702). In that case, it may compromise the strength and durability of the panel, making it less suitable as a building element (e.g., wall panel or roof panel).

In other alternative embodiments, the fiberglass frame opening (704) is also not limited to being accessible from the top base of the fiberglass panel frame (702), and the fiberglass frame cover (710) is not limited to just being fastened on the top base of the fiberglass panel frame (702). The frame opening (704) can be on the frame's (702) bottom base or one of the lateral faces, and the fiberglass frame cover (710) would be modified to cover the exposed side with the frame opening (704). However, the Styro-aircrete (110) would need to be put into the panel frame (702) using a different method. For example, one such embodiment may have the fiberglass frame opening (704) on one of the frame's (702) lateral faces. The panel frame (702) would need to be oriented so that the Styro-aircrete (110) can be directly poured into the panel frame (702) via the modified frame opening (704).

In yet another alternative embodiment, the fiberglass frame (702) and frame cover (710) are already integrated. A small siphon or tube can directly transfer the Styro-aircrete (110) into the fiberglass casing (106, 108, 702, 710), where it can be later removed and replaced with a small circular piece of fiberglass to seal the fiberglass casing (106, 108, 702, 710). This may be advantageous because the fiberglass casing (106, 108, 702, 710) would have nearly no gap (save the tube area) and can provide increased durability. The manufacturing process can also save time since the Styro-aircrete (110) can dry within this alternative fiberglass casing (106, 108, 702, 710), allowing more time to manufacture the Styro-aircrete panel actively. However, the wire meshes and fiberglass fibers would not be present in this fiberglass casing (106, 108, 702, 710) unless the meshes are inserted during the manufacturing of the fiberglass casing (106, 108, 702, 710) at the same time. Furthermore, some Styro-aircrete (110) components, like the foam aggregate pieces (706), may not effectively transfer through the tube/siphon.

1. A method of creating a light-weighted building block, comprising:
providing an enclosing case in a shape that has two base sides and three or more lateral sides with at least one side open and all other sides completely sealed;
wherein the enclosing case is made of a first material;
embedding a mesh sheet with a shape and arrangement in the enclosing case from the opening side;
wherein the mesh sheet is made of a second material;
forming a first mixture by mixing cement and PVA glue with water and a second mixture by mixing a foaming agent and Glycerin to form high-density foam, and shredded Styrofoam with water, each component with a certain ratio;
making Styro-aircrete by mixing the first and second mixtures and pouring it into the enclosing case from the open side(s) of the enclosing case and setting aside the Styro-aircrete to dry and harden;
finishing the building block by sealing the case's open side with a cover made of the first material.

2. The method of claim 1, wherein the enclosing case is made of at least two layers of sheets.

3. The method of claim 1, wherein the first material is fiberglass.

4. The method of claim 1, wherein the building block has a number of block types like a wall panel, roof panel, or support beam.

5. The method of claim 1, wherein the mesh is a wire mesh.

6. The method of claim 1, wherein the second material is iron, steel, copper, tarp, gunny, linen, fiberglass fiber, or hard plastic.

7. The method of claim 1, wherein the mesh sheet's shape and arrangement extend a significant part of the base side.

8. The method of claim 1, wherein the ratio among the cement and water is roughly ninety-four pounds to six gallons.

9. The method of claim 1, wherein the ratio among the cement and high-density foam (surfactant) is roughly ninety-four pounds to ninety-four liters.

10. The method of claim 1, wherein the ratio among the cement and shredded Styrofoam is roughly ninety-four pounds to two hundred and four liters.

11. The method of claim 1, wherein the high-density foam weights roughly three ounces per quart.

12. The method of claim 1, wherein the mesh sheet arrangement is a flat plane, a rectangular-shaped grid, or a shape of an upward triangle.

13. The method of claim 1, further comprising using a fiberglass binding layer sheet to bound two or more same or different types of said light-weighted building blocks together.

14. A light-weighted building block, comprising:
an enclosing case in a shape that has two base sides and three or more lateral sides with all sides completely sealed;
wherein the enclosing case is made of a first material;
at least a mesh sheet with a shape and arrangement is embedded in the enclosing case;
wherein the mesh sheet is made of a second material;
a Styro-aircrete that is formed inside the enclosing case;
wherein a first mixture is formed by mixing cement and PVA glue with water; and a second mixture is formed by mixing a foaming agent and Glycerin to form high-density foam, and shredded Styrofoam with water, each component with a certain ratio;
wherein the Styro-aircrete is created by mixing the first and second mixtures and putting it into the enclosing case, and set aside to dry and harden for a few days.

15. The building block of claim 14, wherein the enclosing case is made of at least two layers of sheets, and the mesh sheet's shape and arrangement extend a significant part of the base side.

16. The building block of claim 14, wherein the first material is fiberglass; wherein the second material may be iron, steel, copper, tarp, gunny, linen, fiberglass fiber, or hard plastic.

17. The building block of claim 14, wherein the building block has a number of block types like a wall panel, roof panel, or support beam; wherein the mesh may be a wire mesh.

18. The building block of claim 14, wherein the mesh sheet's shape and arrangement extend a significant part of the base side; wherein the mesh sheet arrangement is a flat plane, a rectangular-shaped grid, or a shape of an upward triangle.

19. The building block of claim 14, wherein the ratio among the cement, PVA glue, water, high-density foam (surfactant), and shredded Styrofoam is roughly ninety-four pounds vs. a half-liter vs. six gallons vs. ninety-four liters vs. two hundred and four liters; wherein the high-density foam may weight roughly three ounces per quart; wherein each component amount may vary within ±20%.

20. The building block of claim 14, further comprising a fiberglass binding layer sheet to bound two or more same or different types of said light-weighted building blocks together.
